(19) United States
(12) Patent Application Publication
(10) Pub. No.: US 2006/0220776 A1
(43) Pub. Date: Oct. 5, 2006

(54) Thin film device

(75) Inventor: Toshiyasu Fujiwara, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/389,237

(22) Filed: Mar. 27, 2006

(30) Foreign Application Priority Data
Mar. 31, 2005 (JP) 2005-104864

(51) Int. Cl. H01F 5/00

(52) U.S. Cl. 336/200

(57) ABSTRACT

The present invention provides a thin film device in which parasitic capacitance can be reduced as much as possible. In the case where a coil is provided so as to be insulated between an upper magnetic film and a lower magnetic film, the coil is constructed so that the cross section of the coil has the minimum width at its edges closest to the upper and lower magnetic films. Parasitic capacitance generated between the coil and the lower magnetic film and parasitic capacitance generated between the coil and the upper magnetic film are reduced and, in addition, parasitic capacitance generated between turns of the coil is also reduced.

### BACKGROUND OF THE INVENTION

1. Field of the Invention

The present invention relates to a thin film device having a coil.

2. Description of the Related Art

In recent years, a thin film device in which a coil is provided for a base body having conductivity so as to be insulated from the base body in the field of electronic devices for various uses is widely used. An example of a thin film device of this kind is a thin film inductor having a structure in which a magnetic body (magnetic film) is provided as the base body having conductivity and a coil is wound along the surface of the magnetic film. The thin film inductor is a circuit device having inductance.

As per a thin film device as typified by the thin film inductor, as an electronic device on which a thin film device is miniaturized, the thin film device is demanded to achieve a reduction in its profile. To realize a reduction in profile of the thin film device, it is sufficient to narrow the interval between a coil and a magnetic film. When the interval is narrowed, however, since the coil and the magnetic film are close to each other, the parasitic capacitance generated between the coil and the magnetic film tends to increase. When the parasitic capacitance increases, the resonance frequency drops, so that the frequency band which can be used as operation frequency of the thin film device is lowered.

The parasitic capacitance causing drop in the frequency band includes not only the parasitic capacitance generated between the coil and the magnetic film but also parasitic capacitance generated between neighboring turns of the coil. When the interval between the turns is increased while maintaining the number of turns of the coil, that is, the sectional area of the coil is reduced in order to reduce the parasitic capacitance, the parasitic capacitance generated between the turns decreases but, on the other hand, the resistance of the coil increases.

Some techniques for solving the problem of the thin film device caused by the parasitic capacitance have already been proposed.

Concretely, there are known techniques on a thin film device in which upper and lower magnetic films are disposed while sandwiching a coil. In the techniques, slits are formed in each of the magnetic films in order to decrease the parasitic capacitance generated between the coil and the magnetic films (refer to, for example, Japanese Patent Laid-Open Nos. H06-132131, H06-084644, and H08-172015).

There is another known technique on a thin film device having a base body having insulating properties (insulating substrate) in place of a base body having conducting properties, in which a coil is tapered in order to decrease the parasitic capacitance generated between neighboring turns of the coil (refer to, for example, Japanese Patent Laid-Open No. 2004-342864).

### SUMMARY OF THE INVENTION

To improve the performance of a thin film device, the parasitic capacitance has to be reduced as much as possible. In particular, in the case of applying a thin film device to a thin film inductor for high frequency use and the like, it is extremely important to increase the resonance frequency by decreasing the parasitic capacitance in order to set the operation frequency of the thin film inductor to be high. However, the parasitic capacitance has not been sufficiently decreased in a conventional thin film device, and there is scope for improvement.

It is therefore desirable to provide a thin film device in which the parasitic capacitance is reduced as much as possible.

A thin film device according to an embodiment of the invention has a coil provided for a base body having conducting properties so as to be insulated from the base body, and the cross section of the coil has the minimum width at its edge closest to the base body.

In a thin film device according to an embodiment of the invention, in the case where a coil is provided for a base body having conducting properties so as to be insulated from the base body, the coil is constructed so that the cross section of he coil has the minimum width at its edge closest to the base body having conducting properties. In this case, the parasitic capacitance generated between the coil and the base body is reduced and the capacitance generated between turns of the coil is also reduced more than the case where the cross section of the coil does not have the minimum width at its edge closest to the base body having conducting properties.

In a thin film device according to an embodiment of the invention, one base body may be disposed on one side of the coil. In this case, preferably, the cross section of the coil has a shape selected from a group of shapes including a trapezoidal shape and a hexagon shape obtained by combining a trapezoid and a rectangle.

In a thin film device according to an embodiment of the invention, two base bodies may be disposed on one side and the other side of the coil. In this case, preferably, the cross section of the coil has a shape selected from a group of shapes including a hexagon shape and a cross shape.

In a thin film device according to an embodiment of the invention, the base body may be a magnetic body.

In the thin film device according to an embodiment of the invention, in the case where a coil is provided for a base body having conducting properties so as to be insulated from the base body, based on the structural features that the cross section of the coil has the minimum width at its edge closest to the base body, the parasitic capacitance generated between the coil and the base body decreases, and the parasitic capacitance generated between turns of the coil also decreases. Thus, the parasitic capacitance can be reduced as much as possible.

Other and further objects, features, and advantages of the invention will appear more fully from the following description.

### BRIEF DESCRIPTION OF THE DRAWINGS

FIG. 1 is a plan view showing a plan configuration of a thin film device according to a first embodiment of the invention.

FIG. 2 is a cross section showing a sectional configuration of the thin film device along an II-II line shown in FIG. 1.

FIG. 3 is an enlarged cross section showing a sectional configuration of a coil in the thin film device illustrated in FIG. 2.

FIG. 4 is a cross section showing a sectional configuration of a thin film device as a comparative example of the thin film device according to the first embodiment of the invention.

FIG. 5 an enlarged cross section showing a sectional configuration of a coil in the thin film device illustrated in FIG. 4.

FIG. 6 is a cross section showing a modification of the configuration of the coil in the thin film device according to the first embodiment of the invention.

FIG. 7 is a cross section showing another modification of the configuration of the coil in the thin film device according to the first embodiment of the invention.

FIG. 8 is a cross section showing further another modification of the configuration of the coil in the thin film device according to the first embodiment of the invention.

FIG. 9 is a plan view showing a plan configuration of a thin film device according to a second embodiment of the invention.

FIG. 10 is a cross section showing a sectional configuration of the thin film device along an X-X line illustrated in FIG. 9.

FIG. 11 is an enlarged cross section showing a sectional configuration of a coil in the thin film device illustrated in FIG. 9.

FIG. 12 is a cross section showing a sectional configuration of a thin film device as a comparative example of the thin film device according to the second embodiment of the invention.

FIG. 13 is a cross section showing a modification of the configuration of the coil in the thin film device according to the second embodiment of the invention.

FIG. 14 is a cross section showing another modification of the configuration of the coil in the thin film device according to the second embodiment of the invention.

FIG. 15 is a plan view showing a plan configuration of a thin film device according to a third embodiment of the invention.

FIG. 16 is a cross section showing a sectional configuration of the thin film device along an XVI-XVI line illustrated in FIG. 15.

FIG. 17 is a cross section showing a sectional configuration of a thin film device as a comparative example of the thin film device according the third embodiment of the invention.

FIG. 18 is a diagram showing frequency characteristics of thin film inductors of example 1 and comparative example 1.

FIG. 19 is a diagram showing frequency characteristics of thin film inductors of example 2 and comparative example 2.

FIG. 20 is a diagram showing frequency characteristics of thin film inductors of example 3 and comparative example 3.

### DETAILED DESCRIPTION OF THE PRFERRED EMBODIMENTS

Embodiments of the invention will be described in detail hereinbelow with reference to the drawings.

### First Embodiment

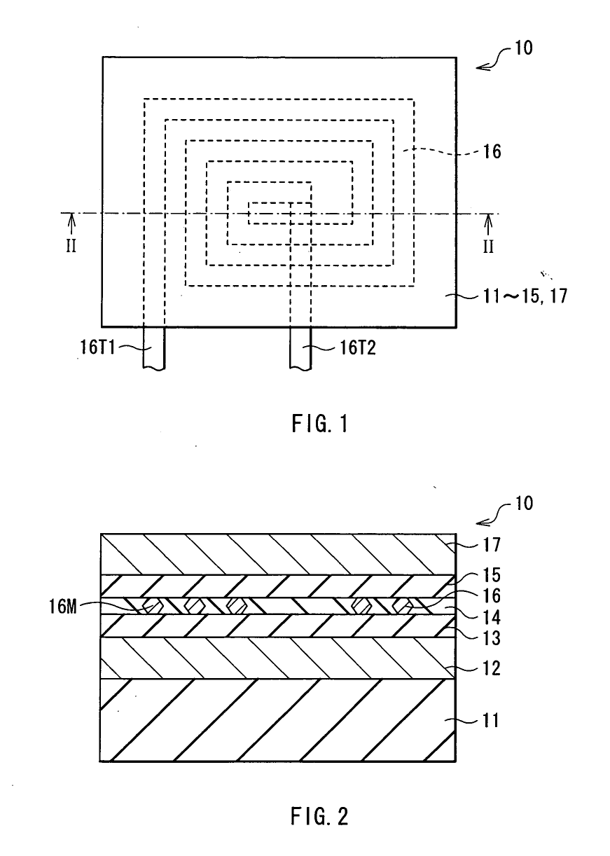

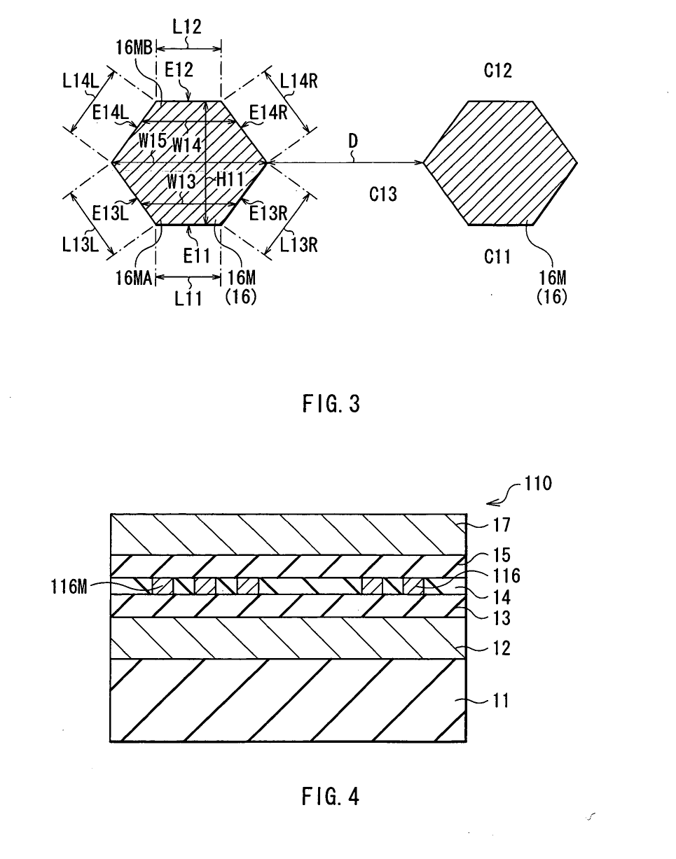

FIGS. 1 to 3 show the configuration of a thin film inductor 10 as a thin film device according to a first embodiment of the invention. FIG. 1 shows a plan view configuration, FIG. 2 shows a sectional configuration taken along line II-II shown in FIG. 1, and FIG. 3 shows an enlarged sectional configuration of a main part (a coil 16) illustrated in FIG. 2.

The thin film inductor 10 has a structure in which a coil is provided between conductive base bodies so as to be insulated from the base bodies. For example as shown in FIGS. 1 and 2, the thin film inductor 10 has a structure in which the coil 16 is provided between a lower magnetic film 12 and an upper magnetic film 17 so as to be buried by a lower insulating film 13, an intermediate insulating film 14, and an upper insulating film 15. More concretely, the thin film inductor 10 has a stacked layer configuration in which the lower magnetic film 12, the coil 16 buried by the lower insulating film 13, the intermediate insulating film 14 and upper insulating film 15, and the upper magnetic film 17 are stacked in this order on a substrate 11.

The substrate 11 supports the whole thin film inductor 10 and is made of, for example, glass, silicon (Si), aluminum oxide (Al₂O₃, so-called alumina), ceramics, a semiconductor, resin, or the like. The material of the substrate 11 is not limited to the series of materials but can be freely selected.

Each of the lower magnetic film 12 and the upper magnetic film 17 is a base body (magnetic body) having conductivity and is provided to increase inductance of the thin film inductor 10. Specifically, the lower magnetic film 12 and the upper magnetic film 17 are disposed so as to face each other so as to sandwich the coil 16, that is, the lower magnetic film 12 is disposed on the one side (lower side) of the coil 16 and the upper magnetic film 17 is disposed on the other side (upper side) of the coil 16. Each of the lower magnetic film 12 and the upper magnetic film 17 is made of a conductive magnetic material such as cobalt (Co) based alloy, iron (Fe) based alloy, nickel iron alloy (NiFe, so-called permalloy) or the like. As the cobalt based alloy, for example, a cobalt zirconium tantalum (CoZrTa) alloy or a cobalt zirconium niobium (CoZrNb) alloy is preferable from the viewpoint of an actual use of the thin film inductor 10.

Each of the lower insulating film 13, the intermediate insulating film 14, and the upper insulating film 15 is provided to electrically isolate the coil 16 from its periphery and is made of an insulating material such as silicon oxide (SiO₂) or the like. In this embodiment, an insulating film by which the coil 16 is buried is constructed by three portions (the lower insulating film 13, the intermediate insulating layer 14, and the upper insulating film 15). However, the invention is not always limited to the configuration. The configuration of the insulating film can be freely set. Further, although the lower insulating layer 13, the intermediate insulating film 14, and the upper insulating film 15 are made of the same material in the embodiment, the invention is not limited to the embodiment. The materials of the lower insulating film 13, the intermediate insulating film 14, and the upper insulating film 15 can be individually freely selected. The lower insulating film 13 may be made of an insulating material having magnetism such as ferrite in place of silicon oxide.

The coil 16 configures the inductor between its one end (a terminal 16T1) and the other end (a terminal 16T2) and is made of a conductive material such as copper (Cu) or the like. The coil 16 has, for example, a spiral structure which is wound along the surfaces of the lower and upper magnetic films 12 and 17 so that the terminals 16T1 and 16T2 are led to the outside. FIG. 2 shows a simplified configuration omitting a portion led to the terminal 16T2, in the coil 16. To be specific, the portion led to the terminal 16T2, in the coil 16 is, for example, disposed at a level lower than a winding portion including the portion led to the terminal 16T1, in the coil 16 so as to be led to the outside without being in contact with the winding portion.

In particular, as shown in FIGS. 2 and 3, a cross section 16M of the coil 16 has the minimum width at its edges closest to the lower magnetic film 12 and the upper magnetic film 17. More concretely, the cross section 16M is defined by a lower edge E11 (having a length L11) positioned on the side closest to the lower magnetic film 12, an upper edge E12 (having a length L12) positioned on the side closest to the upper magnetic film 17, two side edges E13R (having a length L13R) and E13L (having a length L13L) in contact with both ends (right and left ends) of the lower edge E11, respectively, and two side edges E14R (having a length L14R) and E14L (having a length L14L) in contact with both ends (right and left ends) of the upper edge E12 and the side edges E13R and E13L, respectively. That is, the cross section 16M has a hexagon shape defined by six edges (the lower edge E11, the upper edge E12, and the side edges E13R, E13L, E14R, and E14L). FIG. 3 shows only two neighboring cross sections 16M out of the plurality of cross sections 16M shown in FIG. 2. An interval D between the two cross sections 16M (an interval between two neighboring turns in the coil 16) can be freely set.

In this case, the cross section 16M has, for example, a hexagon shape which is bilaterally and vertically symmetrical as follows. For example, (1) each of the lower and upper edges E11 and E12 and the side edges E13R, E13L, E14R, and E14L is straight (not curved), (2) a width W13 of the cross section 16M specified by the side edges E13R and E13L gradually narrows toward the lower edge E11, and (3) a width W14 of the cross section 16M specified by the side edges E14R and E14L gradually narrows toward the upper edge E12. In addition, a width (maximum width) W15 and a height (maximum height) H11 of the cross section 16M can be freely set.

The expression “(the cross section 16M has) the minimum width at its edge closest to the lower magnetic film 12” with respect to the configuration of the cross section 16M indicates that, when attention is paid to the width W13 only in a cross section 16MA of the lower half in the cross section 16M (the lower half when the line indicative of the width W15 is regarded as a boundary), the width W13 is smallest at the lower edge E11 (the width W13=the length L11). The expression “(the cross section 16M has) the minimum width at its edge closest to the upper magnetic film 17” indicates that, when attention is paid to the width W14 only in a cross section 16MB of the upper half of the cross section 16M (the upper half when the line indicative of the width W15 is regarded as a boundary), the width W14 is smallest at the upper edge E12 (the width W14=the length L12). Specifically, as long as the conditions in the two expressions on the widths W13 and W14 of the cross section 16M are satisfied, the expression “(the cross section 16M has) the minimum width at its edges closest to the lower and upper magnetic films 12 and 17” is not limited to the case where the length L11 of the lower edge E11 and the length L12 of the upper edge E12 are equal to each other (L11=L12) but may include the case where the length L11 of the lower edge E11 and the length L12 of the upper edge E12 are different from each other (L11≠L12).

In the thin film device according to the embodiment, in the case where the coil 16 is provided between the lower magnetic film 12 and the upper magnetic film 17 so as to be insulated, the thin film inductor 10 is formed so that the cross section 16M of the coil 16 has a hexagon shape which is bilaterally and vertically symmetrical, specifically, the cross section 16M has the minimum width in its edges closest to the lower and upper magnetic films 12 and 17. Therefore, parasitic capacitance can be reduced as much as possible for the following reason.

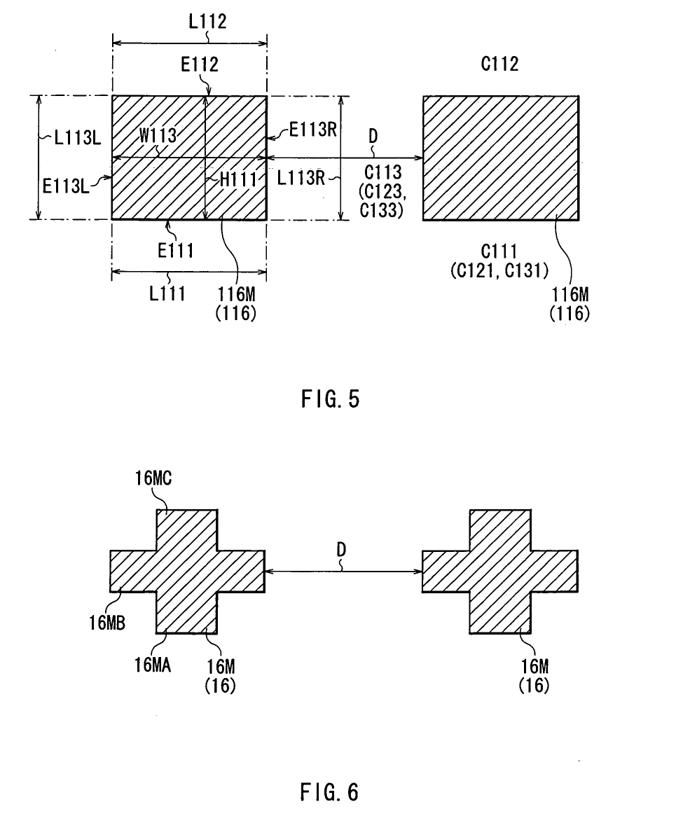

FIGS. 4 and 5 show the configuration of a thin film inductor 110 as a comparative example of the thin film inductor 10 according to the embodiment, and correspond to FIGS. 2 and 3, respectively. The thin film inductor 110 of the comparative example has a configuration similar to that of the thin film inductor 10 of the embodiment (refer to FIG. 1 to FIG. 3) except for the point that a coil 116 is provided in place of the coil 16. A cross section 116M of the coil 116 has, as shown in FIGS. 4 and 5, a constant width. Specifically, the cross section 116M is defined by a lower edge E111 (having a length L111) positioned on the side closest to the lower magnetic film 12, an upper edge E112 (having a length L112) positioned on the side closest to the upper magnetic film 17, and two side edges E113R (having a length L113R) and E113L (having a length L113L) in contact with both ends (right and left ends) of the lower and upper edges E111 and E112, respectively. That is, the cross section 116M has a quadrangle shape defined by four edges (the lower edge E111, the upper edge E112, and the side edges E113R and E113L). More concretely, the cross section 116M has a quadrangle shape (rectangular shape) which is bilaterally and vertically symmetrical as follows. (1) Each of the lower edge E111, the upper edge E112, and the side edges E113R and E113L is straight (not curved), and (2) a width W113 of the cross section 116M specified by the side edges E113E and E113L is constant. The width W113 and a height H111 of the cross section 116M correspond to the width W15 and the height H11 of the thin film inductor 10 (the cross section 16M of the coil 16) according to the embodiment, respectively, (W113=W15, and H111=H11).

In the thin film inductor 110 of the comparative example (refer to FIGS. 4 and 5), the cross section 116M of the coil 116 has a quadrangle shape which is bilaterally and vertically symmetrical. Accordingly, each of the length L111 of the lower edge E111 and the length L112 of the upper edge E112 is equal to the width W113 of the cross section 116M (L111=W113 and L112=W113). In this case, when the width W113 of the cross section 116M is set to be large-in order to decrease resistance of the coil 116, the lengths L111 and L112 become large in accordance with the setting of the width W113 so that parasitic capacitance C111 generated between the coil 116 and the lower magnetic film 12 and parasitic capacitance C112 between the coil 116 and the upper magnetic film 17 increases for the following reason. The magnitude of the parasitic capacitance C111 depends on a facing area between the coil 116 and the lower magnetic film 12 which is determined on the basis of the length L111. On the other hand, the magnitude of the parasitic capacitance C112 depends on a facing area between the coil 116 and the upper magnetic film 17 which is determined on the basis of the length L112. Consequently, as the facing areas increase, the parasitic capacitances C111 and C112 increase.

Moreover, when the cross section 116M of the coil 116 has a quadrangle shape which is bilaterally and vertically symmetrical, each of the lengths L113R and L113L of the side edges E113R and E113L is equal to the height H111 of the cross section 116M (L113R=H111, and L113L=H111) and two side edges E113R and E113L which are adjacent to each other between turns are parallel to each other. In this case, when the height H111 of the cross section 116M is set to be large in order to decrease resistance of the coil 116, the lengths L113R and L113L become large in accordance with the setting of the height H111, so that parasitic capacitance C113 generated between turns increases for the following reason. The magnitude of the parasitic capacitance C113 depends on a facing area between turns determined on the basis of the lengths L113R and L113L. Consequently, as the facing area increases, the parasitic capacitance C113 increases.

Consequently, in the thin film inductor 110 of the comparative example, the parasitic capacitance C111 between the coil 116 and the lower magnetic film 12 and the parasitic capacitance C112 between the coil 116 and the upper magnetic film 17 increase, and the parasitic capacitance C113 generated between the turns of the coil 116 also increases. It is therefore difficult to reduce the whole parasitic capacitance as much as possible.

In contrast, in the thin film inductor 10 of the embodiment (refer to FIGS. 1 to 3), the cross section 16M of the coil 16 has a hexagon shape which is bilaterally and vertically symmetrical. Therefore, each of the length L11 of the lower edge E11 and the length L12 of the upper edge E12 is smaller than the width W15 of the cross section 16M (L11<W15, and L12<W15). In this case, if the width W15 of the cross section 16M is set to be large in order to decrease the resistance of the coil 16, each of the lengths L11 and L12 does not increase in accordance with the setting of the width W15. That is, the lengths L11 and L12 are set to be small separately from the setting of the width W15. Therefore, each of the parasitic capacitance C11 generated between the coil 16 and the lower magnetic film 12 and the parasitic capacitance C12 generated between the coil 16 and the upper magnetic film 17 decreases.

Moreover, when the cross section 16M of the coil 16 has a hexagon shape which is bilaterally and vertically symmetrical, two groups of side edges (the side edges E13R and E14R, and the side edges E13L and E14L) which are adjacent to each other between the turns. In this case, even if the height H11 of the cross section 16M is set to be large in order to decrease the resistance of the coil 16, the two groups of side edges does not contribute to the parasitic capacitance C13 generated between turns. Therefore, the parasitic capacitance C13 decreases.

Accordingly, in the thin film conductor 10 of the embodiment, the parasitic capacitance C11 generated between the coil 16 and the lower magnetic film 12 and the parasitic capacitance C12 generated between the coil 16 and the upper magnetic film 17 decrease and the parasitic capacitance C13 generated between the turns of the coil 16 also decreases. Therefore, the whole parasitic capacitance can be reduced as much as possible.

In the embodiment, particularly, the parasitic capacitance decreases as described above also in the case where the upper and lower magnetic films 17 and 12 are included. Thus, while increasing inductance of the thin film inductor 10 by using the upper and lower magnetic films 17 and 12, the parasitic capacitance can be reduced.

In the case, when the distance between the lower magnetic film 12 and the coil 16 (for example, the thickness of the lower insulating film 13) and the distance between the upper magnetic film 17 and the coil 16 (for example, the thickness of the upper insulating film 15) decrease, the inductor becomes close to a closed magnetic circuit, so that inductance extremely increases. However, since the parasitic capacitance increases, resonance frequency decreases. On the other hand, when the distance between the lower magnetic film 12 and the coil 16 and the distance between the upper magnetic film 17 and the coil 16 increase, the parasitic capacitance decreases, so that the resonance frequency increases. However, the inductance decreases. Since the inductance and the resonance frequency based on the parasitic capacitance have a trade-off relation, it is preferable to set the distance between the lower magnetic film 12 and the coil 16 and the distance between the upper magnetic film 17 and the coil 16 in consideration of balance between the inductance and the resonant frequency based on the parasitic capacitance.

In the case, there is the possibility that direct current superimposing characteristic deteriorates depending on the magnitude of a current flowing in the coil 16. The point is concerned as a problem in actual use. The “deterioration in the direct current superimposing characteristic” is generally a phenomenon such that when the amount of current flowing in a coil is small, inductance increases and, however, when the current amount is large, magnetic saturation occurs in a magnetic film so that inductance decreases. With respect to the point in the embodiment, two magnetic films (the upper and lower magnetic films 17 and 12) are provided on one side (the upper side) of the coil 16 and the other side (lower side). Therefore, in comparison with the case where only one magnetic film is provided on the one side or the other side of the coil 16, the receiving amount of a magnetic flux generated from the coil 16 (the amount of the magnetic flux which can be received in the magnetic film) increases. As a result, the receiving state of the magnetic flux received by the magnetic film (a distribution state of the magnetic flux) changes, that is, occurrence of magnetic saturation is suppressed in the magnetic film. Accordingly, the direct current superimposing characteristic can be improved.

In the embodiment, as described above, by making the cross section 16M of the coil 16 have the minimum width at its edges closest to the lower and upper magnetic films 12 and 17, the parasitic capacitance can be reduced as much as possible, so that the invention can contribute to reduction in the thickness of the thin film inductor 10. Concretely, in association with demand for reduction in the thickness of a thin film device in recent years, reduction in the thickness of the thin film inductor 10 is also demanded. With respect to reduction in the thickness of the thin film inductor 10, for example, as the back grind technique and the technique for manufacturing a thin low-distortion substrate progress, the substrate 11 can made extremely thin. In addition, by controlling deposition thickness, the coil 16 and the insulating films (in this case, for example, the lower insulating film 13, the intermediate insulating film 14, and the upper insulating film 15) can be made extremely thin. In this case, for example, when the thickness of the lower insulating film 13 and the upper insulating film 15 is reduced, the coil 16 becomes close to each of the lower magnetic film 12 and the upper magnetic film 17. Therefore, the parasitic capacitance generated between the coil 16 and the lower magnetic film 12 and the parasitic capacitance generated between the coil 16 and the upper magnetic film 17 easily increase. With respect to this point in the embodiment, by forming the coil 16 as to have the minimum width at its edges closest to the lower and the upper magnetic films 12 and 17 in the cross section 16M, the parasitic capacitance can be reduced. Therefore, as compared with the case where the coil 16 is formed in such a manner that the cross section 16M does not have the minimum width at its edges closest to the lower magnetic film 12 and the upper magnetic film 17, the parasitic capacitance decreases even in the case where the thicknesses of the lower insulating film 13 and the upper insulating film 15 are reduced. Accordingly, reduction in the thickness of thin film inductor 10 can be realized while decreasing the parasitic capacitance in the embodiment.

Although the cross section 16M of the coil 16 has a hexagon shape which is bilaterally and vertically symmetrical in the embodiment as shown in FIG. 3, the invention is not limited to the shape. As long as the cross section 16M has a hexagon shape, the cross section 16M may be bilaterally symmetrical and vertically asymmetrical, bilaterally and vertically asymmetrical, or bilaterally asymmetrical and vertically symmetrical. In these cases as well, effects similar to those of the foregoing embodiment can be obtained.

Although each of the lower edge E11, the upper edge E12, and the side edges E13R, E13L, E14R, and E14L is straight in the embodiment as described with reference to FIG. 3, the invention is not limited to the arrangement. Part or all of the lower edge E11, the upper edge E12, and the side edges E13R, E13L, E14R, and E14L may be curved. In this case as well, effects similar to those of the foregoing embodiment can be obtained.

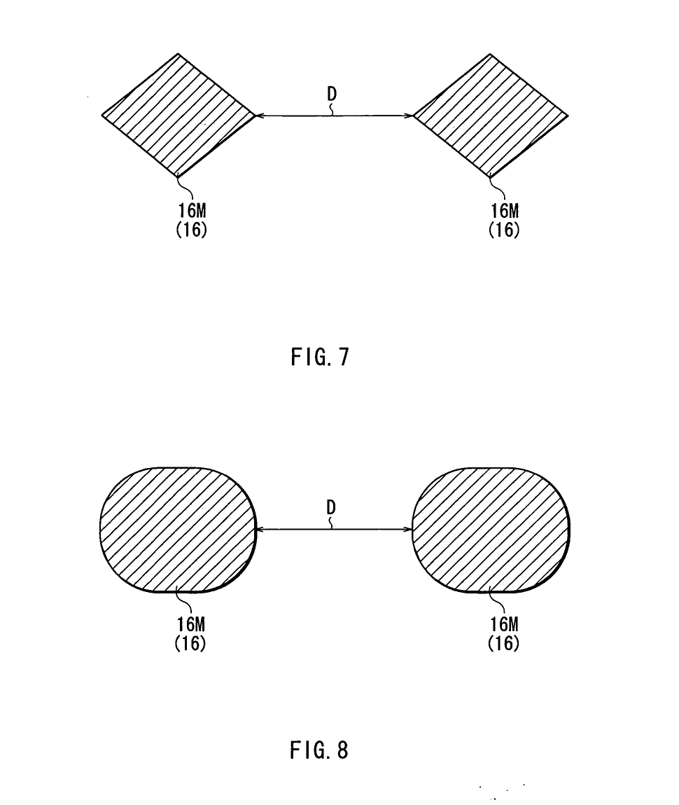

Although the cross section 16M of the coil 16 has a hexagon shape in the embodiment as shown in FIG. 3, the invention is not limited to the shape. As long as the cross section 16M of the coil 16 has the minimum width in its edges closest to the lower magnetic film 12 and the upper magnetic film 17, the shape of the cross section 16M can be freely set. As a concrete example, as shown in FIGS. 6 to 8 corresponding to FIG. 3, the cross section 16M may have a cross shape obtained by combining the cross section 16MA having a narrow rectangular shape, the cross section 16MB having a wide rectangular shape, and a cross section 16MC having a narrow rectangular shape (refer to FIG. 6), a rhomboid shape (refer to FIG. 7) or an almost oval shape (shape in which corners of rectangular are rounded) (refer to FIG. 8). Obviously, also in the cases shown in FIGS. 6 to 8, symmetries (bilateral and vertical symmetries) with respect to the shape of the cross section 16M and the state of each of the edges (straight or curve) can be freely set. In these cases as well, effects similar to those of the foregoing embodiment can be obtained. For information, the shape of the cross section 16M of the coil 16 has to be determined in consideration of balance among the parasitic capacitances C11 to C13 and the resistance of the coil 16.

### Second Embodiment

Next, a second embodiment of the invention will be described.

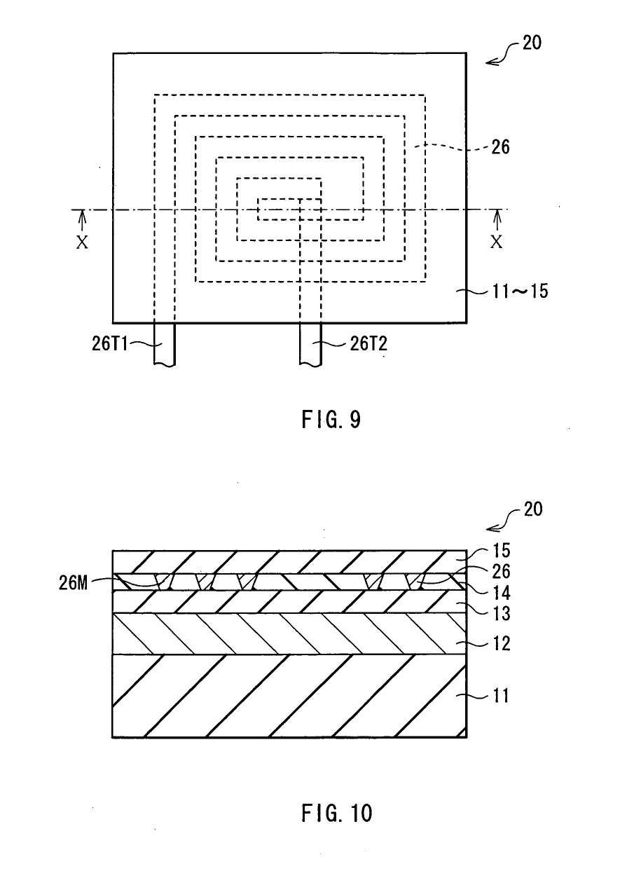

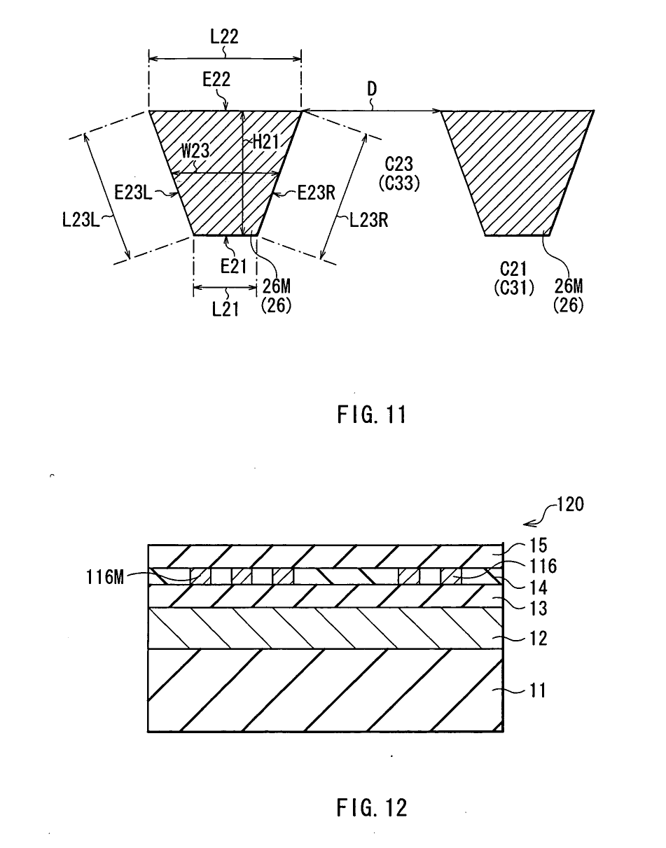

FIGS. 9 to 11 show the configuration of a thin film inductor 20 as a thin film device according to the second embodiment of the invention. FIG. 9 shows a plan view configuration. FIG. 10 shows a sectional configuration along an X-X line shown in FIG. 9. FIG. 11 shows an enlarged sectional configuration of a main part (a coil 26) shown in FIG. 10. FIGS. 9 to 11 correspond to FIGS. 1 to 3 shown in the foregoing first embodiment, respectively. In FIGS. 9 to 11, the same reference numerals are designated to the same components as described in the foregoing first embodiment.

The thin film inductor 20 has a configuration similar to that of the thin film inductor 10 described in the forgoing first embodiment except for the point that the coil 26 is provided in place of the coil 16 and the upper magnetic film 17 is not included but only the lower magnetic film 12 is included. Specifically, the thin film inductor 20 has, for example as shown in FIGS. 9 and 10, a stacked layer structure in which the lower magnetic film 12, and the coil 26 buried by the lower insulating film 13, the intermediate insulating film 14 and the upper insulating film 15 are stacked in this order on the substrate 11.

The coil 26 has, for example, a spiral structure which is wound along a surface of the lower magnetic film 12 so that one end (a terminal 26T1) and the other end (a terminal 26T2) are led to the outside. The material of the coil 26 is similar to that of the coil 16.

In particular, as shown in FIGS. 9 and 10, a cross section 26M of the coil 26 has the minimum width in an edge closest to the lower magnetic film 12. More concretely, the cross section 26M is defined by, for example, a lower edge E21 (having a length L21) positioned on the side closest to the lower magnetic film 12, an upper edge E22 (having a length L22) positioned on the side farthest from the lower magnetic film 12, and two side edges E23R (having a length L23R) and E23L (having a length L23L) in contact with both ends (right and left ends) of the lower edge E21 and the upper edge E22. That is, the cross section 26M has a trapezoidal shape (inverted trapezoidal shape) defined by four edges (the lower edge E21, the upper edge E22, and the side edges E23R and E23L).

The cross section 26M has, for example, a trapezoidal shape which is bilaterally symmetrical in such a manner that (1) each of the lower edge E21, the upper edge E22, and the side edges E23R and E23L is straight (not curved) and (2) a width W23 of the cross section 26M specified by the side edges E23R and E23L gradually decreases toward the lower edge E21. Specifically, the cross section 26M of the coil 26 and the cross section 16M of the coil 16 have a relation such that the length L21 of the lower edge E21 corresponds to each of the length L11 of the lower edge E11 and the length L12 of the upper edge E12 (L21=L11, and L21=L12). The length L22 of the upper edge E22 corresponds to the width W15 (L22=W15). A height (maximum height) H21 of the cross section 26M can be freely set.

In the thin film device according to the embodiment, in the case where the coil 26 is provided over the lower magnetic film 12 so as to be insulated, the thin film inductor 20 is formed so that the cross section 26M of the coil 26 has a trapezoidal shape which is bilaterally symmetrical, that is, has the minimum width at its edge closest to the lower magnetic film 12. Therefore, the parasitic capacitance can be reduced as much as possible for the following reason.

FIG. 12 shows the configuration of a thin film inductor 120 as a comparative example of the thin film inductor 20 according to the embodiment. FIG. 12 corresponds to FIG. 10. The thin film inductor 120 of the comparative example has a configuration similar to that of the thin film inductor 20 of the embodiment (refer to FIGS. 9 to 11) except for the point that, in place of the coil 26, the coil 116 (refer to FIG. 5) described in the comparative example of the foregoing first embodiment is included.

The cross section 116M of the coil 116 has a quadrangle shape which is bilaterally and vertically symmetrical in the thin film inductor 120 of the comparative example (refer to FIGS. 5 and 12). Therefore, as described with respect to the thin film inductor 110 of the comparative example in the foregoing first embodiment, if the width W113 of the cross section 116M is set so as to be large in order to decrease the resistance of the coil 116, a parasitic capacitance C121 generated between the coil 116 and the lower magnetic film 12 increases. If the height H111 of the cross section 116M is set so as to be large in order to decrease the resistance of the coil 116, a parasitic capacitance C123 generated between turns also increases.

In contrast, the thin film inductor 20 of the embodiment (refer to FIGS. 9 to 11), the cross section 26M of the coil 26 has a trapezoidal shape which is vertically symmetrical. Therefore, as described with respect to the thin film inductor 10 in the foregoing first embodiment, even if the width W23 of the cross section 26M is set so as to be sufficiently large in order to decrease the resistance of the coil 26, a parasitic capacitance C21 generated between the coil 26 and the lower magnetic film 12 decreases. Even if a height H21 of the cross section 26M is set so as to be large in order to decrease the resistance of the coil 26, a parasitic capacitance C23 generated between turns decreases. Therefore, in the thin film inductor 20 of the embodiment, both of the parasitic capacitances C21 and C23 decrease, so that a whole parasitic capacitance can be reduced as much as possible.

Although the cross section 26M of the coil 26 has a trapezoidal shape which is vertically symmetrical in the embodiment as shown in FIG. 11, the invention is not limited to the shape. As long as the cross section 26M has a trapezoidal shape, the cross section 26M may be bilaterally asymmetrical. In this case as well, effects similar to those of the foregoing embodiment can be obtained.

Structural features of the thin film device of the invention in the case where the cross section 26M of the coil 26 has a trapezoidal shape which is bilaterally asymmetrical will be described in addition. Specifically, as described in the “Description of the Related Art”, in the art in which a coil is tapered, by tapering only one side, the cross section of the coil has a trapezoidal shape which is vertically asymmetrical. In the art, however, the coil is provided in the base body having insulation properties (insulating base body which does not generate a parasitic capacitance between a coil and itself). Therefore, obviously, it is structurally different from the thin film device of the present invention in which the coil 26 is provided in the base body having electrical conductivity (the lower magnetic film 12 which generates a parasitic capacitance between the coil 26 and itself). Moreover, in the art described above, even if the base body has conductivity, the cross section of the coil still has the maximum width at its edge closest to the base body. Consequently, the art is obviously structurally different from the thin film device of the present invention in which the cross section 26M of the coil 26 has the minimum width at its edge closest to the lower magnetic film 12.

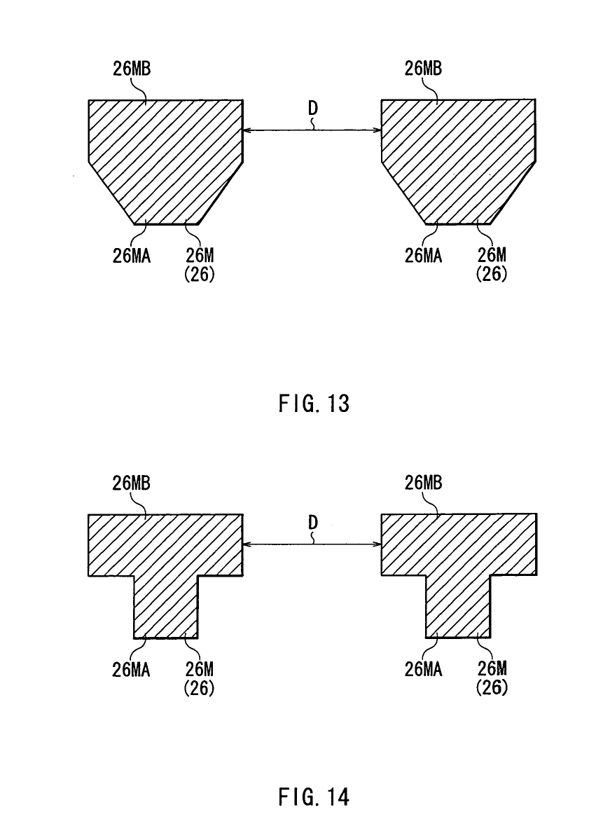

Although the cross section 26M of the coil 26 has a trapezoidal shape in the embodiment as shown in FIG. 11, the invention is not limited to the shape. As long as the cross section 26M of the coil 26 has the minimum width at its edge closest to the lower magnetic film 12, the shape of the cross section 26M can be freely set. As a concrete example, as shown in FIGS. 13 and 14 corresponding to FIG. 11, the cross section 26M may have a hexagon shape in which a cross section 26MA having a trapezoidal shape (inverted trapezoidal shape) and a cross section 26MB having a rectangular shape are combined (refer to FIG. 13) or a projected shape in which the cross section 26MA having a narrow rectangular shape and the cross section 26MB having a wide rectangular shape are combined (refer to FIG. 14). Obviously, also in the cases shown in FIGS. 13 and 14, symmetries (vertical and bilateral symmetries) with respect to the shape of the cross section 26M and the state of each of the edges (straight or curve) can be freely set. Also in these cases, effects similar to those of the foregoing embodiment can be obtained.

The other configurations, actions, effects, and modifications of the thin film inductor 20 according to the embodiment are similar to those of the thin film inductor 10 described in the foregoing first embodiment.

### Third Embodiment

Next, a third embodiment of the invention will be described.

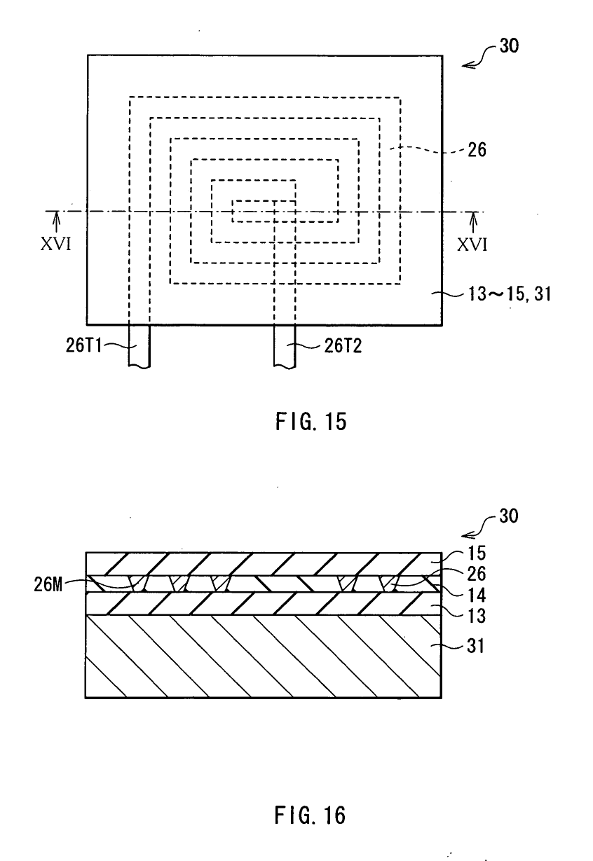

FIGS. 15 and 16 show the configuration of a thin film inductor 30 as a thin film device according to the third embodiment of the invention. FIG. 15 shows a plan view configuration. FIG. 16 shows a sectional configuration along an XVI-XVI line shown in FIG. 15. FIGS. 15 and 16 correspond to FIGS. 9 and 10 in the foregoing second embodiment, respectively. In FIGS. 15 and 16, the same reference numerals are designated to the same components as those in the foregoing second embodiment.

The thin film inductor 30 has a configuration similar to that of the thin film inductor 20 described in the forgoing second embodiment except for the point that, in place of the substrate 11 and the lower magnetic film 12, a semiconductor substrate 31 is provided. Specifically, the thin film inductor 30 has, for example, a structure in which the coil 26 buried by the lower insulating film 13, the intermediate insulating film 14, and the upper insulating film 15 is provided over the semiconductor substrate 31.

The semiconductor substrate 31 is a base body having electrical conductivity and supports the whole thin film inductor 30. The semiconductor substrate 31 is made of a semiconducting material such as silicon (Si) or the like. For information, in the case where the semiconductor substrate 31 is made of silicon, the lower insulating film 13 adjacent to the semiconductor substrate 31 may be, for example, a thermal oxidation film (SiO₂) formed by thermally oxidizing the surface of silicon. The material of the semiconductor substrate 31 is not limited to the silicon described above, but can be freely selected.

In the thin film device of the embodiment, in the case where the coil 26 is provided over the semiconductor substrate 31 so as to be insulated, the thin film inductor 30 is formed so that the cross section 26M of the coil 26 has a trapezoidal shape which is bilaterally symmetrical, that is, has the minimum width at its edge closest to the semiconductor substrate 31. Therefore, the parasitic capacitance can be reduced as much as possible for the following reason.

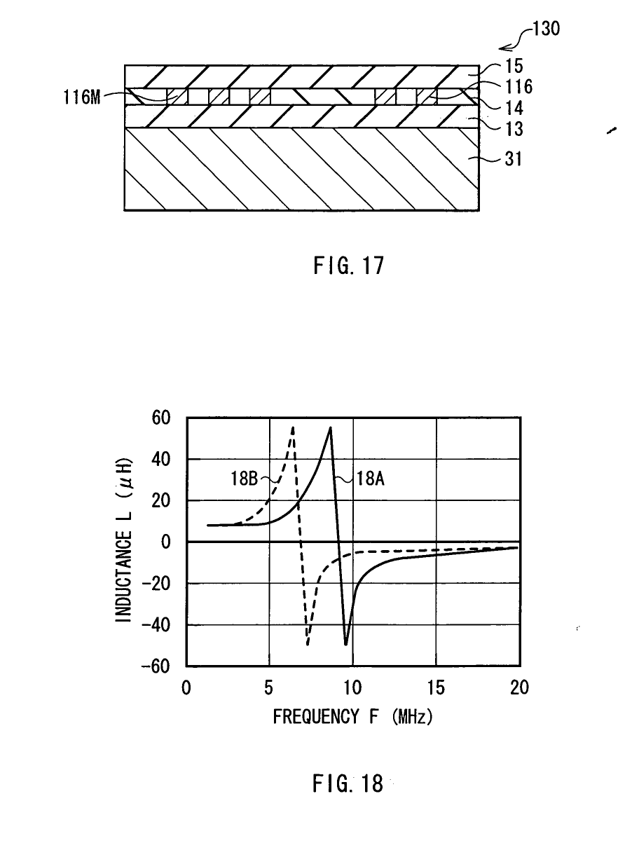

FIG. 17 shows the configuration of a thin film inductor 130 as a comparative example of the thin film inductor 30 according to the third embodiment and corresponds to FIG. 16. The thin film inductor 130 of the comparative example has a configuration similar to that of the thin film inductor 30 of the third embodiment (refer to FIGS. 15 and 16) except for the point that, in place of the coil 26, the coil 116 described as the comparative example in the foregoing first embodiment (refer to FIG. 5) is provided.

In the thin film inductor 130 of the comparative example (refer to FIGS. 5 and 17), the cross section 116M of the coil 116 has a quadrangle shape which is bilaterally and vertically symmetrical. Therefore, as described with respect to the thin film inductor 110 of the comparative example in the foregoing first embodiment, when the width 113 of the cross section 116M is set to be large in order to decrease the resistance of the coil 116, a parasitic capacitance C131 generated between the coil 116 and the semiconductor substrate 31 increases. When the height H111 of the cross section 116M is set to be large in order to decrease the resistance of the coil 116, a parasitic capacitance C133 generated between turns also increases.

In contrast, in the thin film inductor 30 of the embodiment (refer to FIGS. 11, 15, and 16), the cross section 26M of the coil 26 has a trapezoidal shape which is bilaterally symmetrical. Therefore, as described with respect to the thin film inductor 20 in the foregoing second embodiment, if a width W23 of the cross section 26M is set to be large in order to decrease the resistance of the coil 26, a parasitic capacitance C31 generated between the coil 26 and the semiconductor substrate 31 decreases. Similarly, if the height H21 of the cross section 26M is set to be large in order to decrease the resistance of the coil 26, a parasitic capacitance C33 generated between turns decreases. Accordingly, both of the parasitic capacitances C31 and C33 decrease in the thin film inductor 30 according to the third embodiment, so that a whole parasitic capacitance can be reduced as much as possible.

In the third embodiment, particularly, also in the case where the semiconductor substrate 31 is included, the parasitic capacitance decreases as described above. Therefore, while preventing the thin film inductor 30 from being electrically adversely influenced from the periphery by using the semiconductor substrate 31, the parasitic capacitance can be reduced. By preventing the electric adverse influence, for example, occurrence of noise in the thin film inductor 30 can be suppressed and occurrence of electromagnetic induction can be suppressed in the thin film inductor 30.

The other configurations, actions, effects, and modifications of the thin film inductor 30 according to the third embodiment are similar to those of the thin film inductors 10 and 20 described in the foregoing first and second embodiments.

### EXAMPLES

Next, examples of the invention will be described.

First, a series of thin film inductors described in the foregoing embodiments were manufactured as thin film devices.

### Example 1

By the following procedures, the thin film inductor described in the foregoing first embodiment was manufactured. Specifically, a silicon substrate as a substrate was prepared and, after that, first, cobalt zirconium niobium alloy (CoZrNb) was deposited by using sputtering, thereby forming a lower magnetic film (relative permeability μ=1000) so as to have a thickness of 10 μm on the substrate. Subsequently, silicon oxide (SiO₂) was deposited by using chemical vapor deposition (CVD), thereby forming a lower insulating film (relative permittivity ε=4) SO as to have a thickness of 1 μm on the lower magnetic film. After that, titanium (Ti) was deposited by using sputtering, thereby forming a seed film having a thickness of 300 nm on the lower insulating film. Subsequently, a positive photoresist was applied on the surface of the seed film, thereby forming a photoresist film. After that, by patterning (exposing/developing) the photoresist film by using photolithography process, a photoresist pattern having a thickness of 30 μm was formed on the seed film. At the time of forming the photoresist pattern, an opening having a shape corresponding to the sectional shape of a coil was opened by adjusting the exposure range and the exposure amount. More concretely, in the photolithography process, a photo mask was used including a light shielding part which has a pattern shape corresponding to the shape in plan view (spiral structure) of the coil and does not transmit light for exposure and a light transmitting part which is disposed around the light shielding part and transmits light for exposure. In particular, a photo mask is used, in which light amount adjusting parts that gradually reduce the light transmission amount toward the sides close to/far from (apart from) a position corresponding to the center of the coil are provided on the close/far sides in the light shielding part. Subsequently, by using the photoresist pattern, a copper (Cu) plating film was grown with the seed film as an electrode film, thereby forming the coil having a thickness of 20 μm on the seed film. The coil was formed so as to have a spiral structure (the number of turns=21) and have a cross section of a hexagon shape which is bilaterally and vertically symmetrical (L11=20 μm, L12=20 μm, W15=60 μm, and H11=20 μm) (refer to FIG. 3). Subsequently, the used photoresist pattern was removed to partially expose the seed film and, after that, the seed film was subjected to wet etching using etchant, thereby partially removing an exposed portion of the seed film. Subsequently, silicon oxide was deposited by using CVD, thereby forming an intermediate insulating film (relative permittivity ε=4) so as to cover the coil and the lower insulating film around the coil. After that, by subsequently using the CVD, silicon oxide was deposited, thereby forming an upper insulating film (relative permittivity ε=4) so as to have a thickness of 1 μm on the intermediate insulating film. Finally, by using sputtering, cobalt zirconium niobium alloy (CoZrNb) was deposited, thereby forming an upper magnetic film (relative permeability μ=1000) so as to have a thickness of 10 μm on the upper insulating film. As a result, the thin film inductor described in the foregoing first embodiment was completed (refer to FIGS. 1 to 3).

### Example 2

By procedures similar to the manufacturing procedures of the example 1 except for the points that the coil was formed so that its cross section has a trapezoidal shape which is bilaterally symmetrical (L21=20 μm, L22=60 μm, and H21=20 μm) (refer to FIG. 11) and the upper magnetic film was not formed on the upper insulating film, the thin film inductor described in the foregoing second embodiment was manufactured (refer to FIGS. 9 to 11).

### Example 3

By procedures similar to the manufacturing procedures of the example 2 except for the points that a silicon substrate was used as the semiconductor substrate in place of the substrate and the lower magnetic film, and the lower insulating film was formed on the semiconductor substrate, the thin film inductor described in the foregoing third embodiment was manufactured (refer to FIGS. 11, 15, and 16).

### Comparative Example 1

By procedures similar to the manufacturing procedures of the example 1 except for the point that the coil was formed so that the cross section has a quadrangle shape which is bilaterally and vertically symmetrical, the thin film inductor described as the comparative example in the foregoing first embodiment was manufactured (refer to FIGS. 4 and 5). At the time of forming the coil, in order to make the resistance equal to that of the example 1 (to make the cross section areas of the coils coincide), dimensions of the cross section of the coil were set so that L111 is equal to 40 μm, L112 is equal to 40 μm, and H111 is equal to 20 μm.

### Comparative Example 2

By procedures similar to the manufacturing procedures of the example 2 except for the point that the coil was formed so that the cross section has a quadrangle shape which is bilaterally and vertically symmetrical, the thin film inductor described as the comparative example in the foregoing second embodiment was manufactured (refer to FIGS. 5 and 12). At the time of forming the coil, in order to make the resistance equal to that of the example 2, the dimensions of the cross section of the coil were set so that L111 is equal to 40 μm, L112 is equal to 40 μm, and H111 is equal to 20 μm.

### Comparative Example 3

By procedures similar to the manufacturing procedures of the example 3 except for the point that the coil was formed so that the cross section has a quadrangle shape which is bilaterally and vertically symmetrical, the thin film inductor described as the comparative example in the foregoing third embodiment was manufactured (refer to FIGS. 5 and 17). At the time of forming the coil, dimensions of the cross section of the coil were set in a manner similar to the comparative example 2.

Operating characteristics of the thin film inductors of the examples 1 to 3 and the comparative examples 1 to 3 were examined and the following series of results were obtained.

First, frequency characteristics of the thin film inductors of the example 1 and the comparative example 1 were examined and results shown in FIG. 18 were obtained. FIG. 18 shows frequency characteristics of the thin film inductors of the example 1 and the comparative example 1. The “horizontal axis” denotes a frequency F (MHz) and the “vertical axis” denotes an inductance L (μH). In FIG. 18, “18A (solid line)” denotes the thin film inductor of the example 1 and “18B (broken line)” denotes the thin film inductor of the comparative example 1.

As understood from the results shown in FIG. 18, the resonant frequency of the thin film inductor of the example 1 (18A) is higher than that of the thin film inductor of the comparative example 1 (18B). Accordingly, in the thin film inductor of the invention, in the case where the coil is provided between the upper and lower magnetic films so as to be insulated, by making the cross section of the coil have a hexagon shape which is bilaterally and vertically symmetrical, the resonance frequency can be increased.

The characteristics of the thin film inductors of the example 1 and the comparative example 1 were concretely examined and results shown in Table 1 were obtained. Table 1 shows the characteristics of the thin film inductors of the example 1 and the comparative example 1. As the characteristics, “inductance Ls (μH)”, “parasitic capacitance Cp (pF)”, and “resonance frequency Fr (MHz)” are shown. The characteristics of the thin film inductors were examined by calculating the inductance Ls and the parasitic capacitance Cp by an electromagnetic analysis using finite element method and calculating the resonance frequency Fr by using a relational equation (Fr=(½π)(Ls·Cp)^{-1/2}) between the inductance Ls, the parasitic capacitance Cp, and the resonance frequency Fr.

TABLE 1

| | | Parasitic | Resonance |
|---|---|---|---|
| | Inductance | capacitance | frequency |
| | Ls (μH) | Cp (pF) | Fr (MHz) |
| Example 1 | 8.26 | 38.1 | 8.98 |
| Comparative | 8.26 | 65.1 | 6.87 |
| example 1 | | | |

As understood from the results shown in Table 1, in the thin film inductor of the example 1, the inductance Ls was 8.26 μH, the parasitic capacitance Cp was 38.1 pF, and the resonance frequency Fr was 8.98 MHz. On the other hand, in the thin film inductor of the comparative example 1, the inductance Ls was 8.26 μH, the parasitic capacitance Cp was 65.1 pF, and the resonance frequency Fr was 6.87 MHz. It indicates that, in thin film inductor of the example 1, as compared to the thin film inductor of the comparative example 1, the inductance Ls is that of the comparative example 1 and, on the other hand, the parasitic capacitance Cp decreases on the basis of the shape of the cross section of the coil (hexagon shape which is bilaterally and vertically symmetrical), so that the resonance frequency Fr increases. As a result, it was confirmed that, in the thin film inductor of the invention, by reducing the parasitic capacitance and increasing the resonance frequency, the frequency band which can be used as an operation frequency can be set to be high.

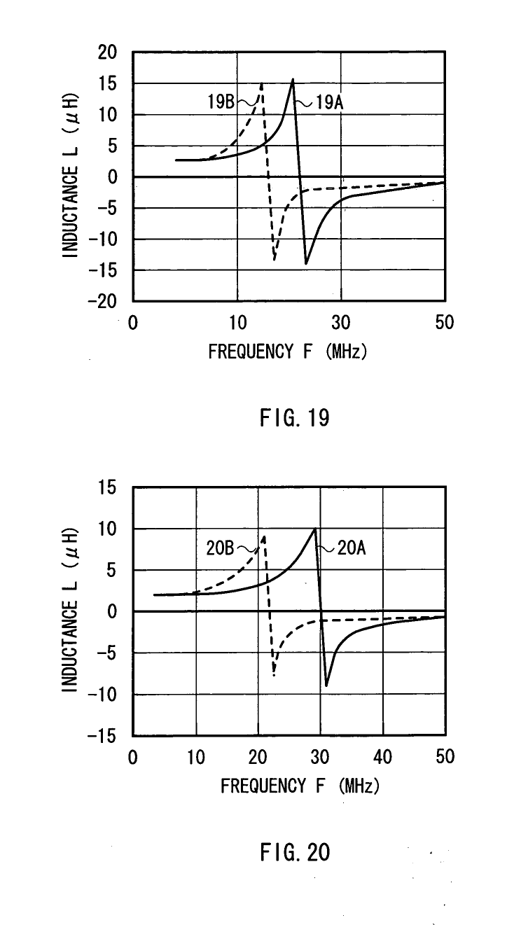

Subsequently, frequency characteristics of the thin film inductors of the example 2 and the comparative example 2 were examined and results shown in FIG. 19 were obtained. FIG. 19 shows frequency characteristics of the thin film inductors of the example 2 and the comparative example 2, which correspond to the frequency characteristics shown in FIG. 18. In FIG. 19, “19A (solid line)” indicates the thin film inductor of the example 2 and “19B (broken line)” indicates the thin film inductor of the comparative example 2.

As understood from the results shown in FIG. 19, the resonance frequency of the thin film inductor of the example 2 (19A) is higher than that of the thin film inductor of the comparative example 2 (19B). It was confirmed from the above that, in the thin film inductor of the invention, in the case where the coil is provided over the lower magnetic film so as to be insulated, by making the cross section of the coil have a trapezoidal shape which is bilaterally symmetrical, the resonance frequency can be increased.

The characteristics of the thin film inductors of the example 2 and the comparative example 2 were concretely examined and results shown in Table 2 were obtained. Table 2 shows the characteristics of the thin film inductors of the example 2 and the comparative example 2, which correspond to the characteristics shown in Table 1.

TABLE 2

| | | Parasitic | Resonance |
|---|---|---|---|
| | Inductance | capacitance | frequency |
| | Ls (μH) | Cp (pF) | Fr (MHz) |
| Example 2 | 2.36 | 17.7 | 24.6 |
| Comparative | 2.36 | 32.8 | 18.1 |
| example 2 | | | |

As understood from the results shown in Table 2, in the thin film inductor of the example 2, the inductance Ls was 2.36 μH, the parasitic capacitance Cp was 17.7 pF, and the resonance frequency Fr was 24.6 MHz. On the other hand, in the thin film inductor of the comparative example 2, the inductance Ls was 2.36 μH, the parasitic capacitance Cp was 32.8 pF, and the resonance frequency Fr was 18.1 MHz. This indicates that, in thin film inductor of the example 2 as compared with that of the comparative example 2, the inductance Ls is equal to that of the comparative example 2 but the parasitic capacitance Cp decreases on the basis of the shape of the cross section of the coil (trapezoidal shape which is bilaterally symmetrical), so that the resonance frequency Fr increases. As a result, it was confirmed that, in the thin film inductor of the invention, by reducing the parasitic capacitance and increasing the resonance frequency, the frequency band which can be used as an operation frequency can be set to be high.

Finally, the frequency characteristics of the thin film inductors of the example 3 and the comparative example 3 were examined and results shown in FIG. 20 were obtained. FIG. 20 shows the frequency characteristics of the thin film inductors of the example 3 and the comparative example 3, which correspond to the frequency characteristics shown in FIG. 18. In FIG. 20, “20A (solid line)” indicates the thin film inductor of the example 3 and “20B (broken line)” indicates the thin film inductor of the comparative example 3.

As understood from the results shown in FIG. 20, the resonance frequency of the thin film inductor of the example 3 (20A) is higher than that of the thin film inductor of the comparative example 3 (20B). It is accordingly confirmed that, in the thin film inductor of the invention, in the case where the coil is provided over the semiconductor substrate so as to be insulated, by making the cross section of the coil have a trapezoidal shape which is bilaterally symmetrical, the resonance frequency can be increased.

The characteristics of the thin film inductors of the example 3 and the comparative example 3 were concretely examined and results shown in Table 3 were obtained. Table 3 shows the characteristics of the thin film inductors of the example 3 and the comparative example 3, which correspond to the characteristics shown in Table 1.

TABLE 3

| | | Parasitic | Resonance |
|---|---|---|---|
| | Inductance | capacitance | frequency |
| | Ls (μH) | Cp (pF) | Fr (MHz) |
| Example 3 | 1.58 | 17.7 | 30.1 |
| Comparative | 1.58 | 32.8 | 22.1 |
| example 3 | | | |

As understood from the results shown in Table 3, in the thin film inductor of the example 3, the inductance Ls was 1.58 μH, the parasitic capacitance Cp was 17.7 pF, and the resonance frequency Fr was 30.1 MHz. On the other hand, in the thin film inductor of the comparative example 3, the inductance Ls was 1.58 μH, the parasitic capacitance Cp was 32.8 pF, and the resonance frequency Fr was 22.1 MHz. This indicates that, in the thin film inductor of the example 3 as compared to that of the comparative example 3, the inductance Ls is equal to that of the comparative example 3 but the parasitic capacitance Cp decreases on the basis of the shape of the cross section of the coil (trapezoidal shape which is bilaterally symmetrical), so that the resonance frequency Fr increases. It was therefore confirmed that, in the thin film inductor of the invention, by reducing the parasitic capacitance and increasing the resonance frequency, the frequency band which can be used as an operation frequency can be set to be high. In this case, particularly, the resonance frequency Fr exceeds 30 MHz, and the operation frequency of the thin film inductor can be set to be extremely high.

Although the invention has been described above by the embodiments and the examples, the invention is not limited to the foregoing embodiments and the examples but can be variously modified. Concretely, for example, in the embodiments and the examples, as the shape of the cross section of the coil, a hexagon shape, a cross shape, a rhomboid shape, and an almost simplified oval shape have been described with respect to the case where the coil is provided between the upper and lower magnetic films so as to be insulated, and a trapezoidal shape, and a hexagon shape obtained by combining a trapezoid and a rectangle and a projected shape have been described with respect to the case where the coil is provided over the lower magnetic film or the semiconductor substrate so as to be insulated. However, the invention is not limited to the shapes. That is, as long as the section has the minimum width at its edge closest to the base body having conductivity such as the lower magnetic film, the upper magnetic film, or the semiconductor substrate, the shape of the cross section of the coil can be freely set. Obviously, the base body having conductivity is also not always limited to the lower magnetic film, the upper magnetic film, or the semiconductor substrate. As long as the base body has conductivity, the base body can be freely set.

Although the coil has a spiral structure in the foregoing embodiments and examples, the invention is not limited to the structure. The coil may have a structure other than the spiral structure. Examples of the “other structures” are a meander structure, a helical structure, a solenoid structure and the like. In any of these cases, effects similar to those of the foregoing embodiments and examples can be obtained.

Although the case of applying the thin film device of the invention to the thin film inductor has been described in the foregoing embodiments and examples, the invention is not always limited to the case. For example, the thin film device of the invention may be also applied to a device other than the thin film inductor. Examples of the “other devices” are a thin film transformer, micro electro mechanical systems (MEMS), and a filter or a module including a thin film inductor, a thin film transformer or an MEMS. Also in the case of applying the thin film device of the invention to each of the other devices, effects similar to those of the foregoing embodiments and examples can be obtained.

The thin film device of the invention can be applied to, for example, a thin film inductor, a thin film transformer, MEMS, a filter or a module including the thin film inductor, the thin film transformer, or MEMS, and the like.

Obviously many modifications and variations of the present invention are possible in the light of the above teachings. It is therefore to be understood that within the scope of the appended claims, the invention may be practiced otherwise than as specifically described.

1. A thin film device comprising a coil provided for a base body having conducting properties so as to be insulated from the base body,
wherein cross section of the coil has the minimum width at its edge closest to the base body.

2. The thin film device according to claim 1, wherein one base body is disposed on one side of the coil.

3. The thin film device according to claim 2, wherein the cross section of the coil has a shape selected from a group of shapes including a trapezoidal shape and a hexagon shape obtained by combining a trapezoid and a rectangle.

4. The thin film device according to claim 1, wherein two base bodies are disposed on one side and the other side of the coil.

5. The thin film device according to claim 4, wherein the cross section of the coil has a shape selected from a group of shapes including a hexagon shape and a cross shape.

6. The thin film device according to claim 1, wherein the base body is a magnetic body.

7. The thin film device according to claim 2, wherein the base body is a magnetic body.

8. The thin film device according to claim 3, wherein the base body is a magnetic body.

9. The thin film device according to claim 4, wherein the base body is a magnetic body.

10. The thin film device according to claim 5, wherein the base body is a magnetic body.
